(19) United States
(12) Patent Application Publication
(10) Pub. No.: US 2015/0061419 A1
(43) Pub. Date: Mar. 5, 2015

(54) ELECTRIC HEATING DEVICE WITH OUTPUT GREATER THAN INPUT

(71) Applicant: Yangyuan LI, Beihai (CN)

(72) Inventor: Yangyuan LI, Beihai (CN)

(21) Appl. No.: 14/447,642

(22) Filed: Jul. 31, 2014

(30) Foreign Application Priority Data
Aug. 29, 2013 (CN) 201310386791.1
Jun. 11, 2014 (CN) 201410258328.3

(51) Int. Cl. H02K 1/17

(52) U.S. Cl. CPC H02K 1/17; H02K 53/00
USPC 310/48; 74/DIG. 9

(57) ABSTRACT

The utility model discloses an electric heating device with an output greater than an input, including a stator, a rotor, an input controller and a base, characterized in that: the stator is composed of a permanent magnet and an electromagnet, the permanent magnet is disposed externally to the electromagnet. The rotor is composed of a rotor body and a rotor shaft, the rotor body is wholly or partly formed of ferromagnetic material. An end portion at one end of an electromagnet core faces the rotor body and remains a gap with the rotor body. The end portion may be magnetized with an N pole or an S pole under an action of the external permanent magnet. The input controller is connected with an electromagnetic coil. The utility model not only may achieve an output greater than an input, but also may achieve a 100% “output efficiency”.

### CROSS-REFERENCE TO RELATED APPLICATION

This application claims the priority benefit of Chinese patent application No. 201310386791.1, filed Aug. 29, 2013 and No. 201410258328.3 filed Jun. 11, 2014. The entirety of the above-mentioned application is hereby incorporated by reference herein and made a part of specification.

### BACKGROUND OF THE INVENTION

1. Field of the Invention

The present invention generally relates to an electric heating device (an electric warm air unit), in particular to an electric heating device with an output greater than an input.

2. Background of the Invention

The concept of an output greater than an input is well known to those skilled in the art (which is a first one of the definitions of a perpetual motion machine). Although there have been many people around the world conducting continuous studies and explorations on the worldwide problem of an output greater than an input (including the problem of a machine that does work to the outside without consumption of energy—a second one of the definitions of a perpetual motion machine), none of them have found solutions to the problem whether in theory or in practical so far. In the past two or three decades, there are more than 200 research institutions in just Russia searching on this problem secretly. In the 1980s, an invention patent application No. WO83/01353 “electromagnetic momentum engine” shocking the United States and even the world, which was expected to profit billions of dollars annually, ended with “it is built on the basis of violation of the scientific law of conservation of energy, without any arguments or facts”.

The law of conservation of energy is still an important law in mechanics and the whole natural science, but it still evolves. In 1905 the famous thesis “a heuristic interpretation of the radiation and transformation of light” published by Einstein revealed the law of conservation of energy, that is, in an isolated system, the sum of the relative kinetic energy and static energy of all the particles remains unchanged in the interaction process, called the law of conservation of energy.

Nowadays, as the newest research on the law of conservation of energy, researchers believe that the law of conservation of energy requires restrictions of conditions, and it is not universally applicable in any circumstances and in any time and space, and they believe that time translation invariance is a condition of conservation of energy. Also, through analysis on the law of conservation of energy, some researchers believe that transformation of various forms of energy follows the principle of equal transformation is a basic condition of the establishment of the law of conservation of energy, and they point out that it is a lack of knowledge to law of conservation of energy for the physics community to believe that Σ E being a constant equals to the law of conversation of energy in a long run. The understanding and research on the law of conversation of energy needs to be carried on further.

Throughout the history of the invention of perpetual motion machine, it is obvious that many inventors have been tried to destroy or overthrow the law of conservation of energy, and only a few of them do not understand the law of conservation of energy. However, almost all the inventors are interested in permanent magnets. Obviously, except for permanent magnets, hardly a device can be conceived to be a source of power in a small “isolated system”—at least, they understand that energy cannot be created from nothing (a third one of the “definitions” of the perpetual motion machine: a machine doing work to the outside by utilizing a permanent magnet).

The idea of the present invention to solve the problem lies in that, an output greater than an input is built on the basis of conservation of energy (achieving an output greater than an input by utilizing the law of conservation of energy).

### BRIEF SUMMARY OF THE INVENTION

Hereinafter, a dialectical relationship in building an output greater than an input on the basis of conservation of energy is explained by an assumption.

Assuming that liquid medicine in a sprayer represents a permanent magnet, compressed gas entering the sprayer represents “electrical energy”, and mist mixed by expansion gas and medicine mist ejected from a nozzle represents “thermal energy+mechanical energy” (the compressed gas transformed into the expansion gas—represents “electrical energy” transformed into “thermal energy”; the liquid medicine transformed into the medicine mist—represents the permanent magnet transformed into “mechanical energy”), then: “electrical energy” is input, and “thermal energy+mechanical energy” is output. Since the transform process of compressed gas of a mass unit sprayed from the nozzle transformed to expansion gas of a mass unit is conservation of energy, so the process of “electrical energy” transformed to “thermal energy” follows a process of “conservation of energy”, thereby, “thermal energy+mechanical energy”>“electrical energy”. Further, an output greater than in input built on the basis of conservation of energy exists.

It can be seen from the above that, spraying medicine mist needs to consume expansion gas, that is, discharging “mechanical energy” needs to consume “electrical energy”.

In summary, we believe that the solution to the problem lies in that: discharge of one form of energy must be accompanied by consumption of another form of energy.

For example, an atomic bomb is a nuclear weapon made by the principle that nuclear fission reaction discharges a lot of energy. Nuclear charge is generally plutonium-239 and uranium-235. When an ignition apparatus ignites an ordinary explosive, the two charges may be pushed together to make the overall mass greater than a critical mass. Then, under a neutron bombardment, a nuclear fission chain reaction is generated to produce a nuclear explosion immediately afterwards.

TNT explosives may discharge chemical energy rapidly in a form of explosion and do work to surrounding medium. Detonating TNT explosives needs to use a fuse cord and detonators: the fuse cord has been well cut is inserted into a cavity of the detonators to make a detonating cap, then the detonating cap is inserted into an explosive roll to make a detonating explosive roll, and afterwards the detonating explosive roll is put inside an explosive pack. Thus, the explosives may be detonated and exploded once the fuse cord is ignited.

The atomic bomb needs to be ignited by the explosives, the explosives need to be ignited by the detonators, the detonators need to be ignited by the fuse cord, and the fuse cord needs to be ignited by fire . . . . It can be seen from above that, the discharge of the energy of a substance such as the atomic bomb has a property of “discharge of one form of energy is necessarily accompanied by consumption of another form of energy”. This property is embodied in discharge process of any energy by any substance, and is a common property of discharge of energy.

For the same reason, discharge of a form of permanent magnet energy is necessarily accompanied by consumption of another form of electrical energy. Briefly, discharge energy by consuming energy, that is, discharge magnetic energy by consuming mechanical energy.

Whether the well-known permanent magnet motors belong to the category of “discharge magnetic energy by consuming electricity power”? The answer is negative. They are just transforming electrical energy into mechanical energy under the action of the permanent magnet, and they even cannot transform electrical energy into mechanical energy 100% and output outside because part of the energy is transformed into thermal energy (causing components such as coils to generate heat and dissipate the heat to the atmosphere). Whether in past or in present, maximize the output efficiency of conventional motors are always a goal assiduously sought by numerous scientific and technical personnel. However, no matter how hard people worked, heat loss issue (of motors) cannot be avoided and always affects the improvement of the output efficiency of motors. Achieving close to 98% of output efficiency is quite difficult, let alone 100%.

Since the heat loss is impossible to be eliminated completely (the existing superconducting motors can only achieve 99%), why cannot this part of heat loss be recycled and utilized and taken as the output of a device together in a form of a sum of thermal energy+mechanical energy, by the modes in the above assumption, so as to achieve the objective of “an output greater than an input” in a form of double-energy output?

According to the property “discharge of a form of permanent magnet energy is necessarily accompanied by consumption of another form of electrical energy”, it may be concluded that, the double-energy output of discharge magnetic energy by consuming mechanical energy is substantially a double-track output. When the input electrical energy consumed is 100% transformed into thermal energy and is output (the transform process follows the law of conservation of energy), the sum of the double-output is greater than the input.

The objective of the invention is to provide an electric heating device with an output greater than in input that discharges magnetic energy by consuming mechanical energy.

An electric heating device with an output greater than an input, including a stator, a rotor, an input controller and a base, characterized in that: the stator is composed of a permanent magnet and an electromagnet, the permanent magnet is disposed externally around one end of the electromagnet or connected to one end of an electromagnet core, the permanent magnet disposed externally or connected to one end of the electromagnet can magnetize an N pole or an S pole at the other end of the electromagnet core, a magnetized end magnetized with the N pole or the S pole faces the rotor and maintains a gap with the rotor. The rotor is composed of a rotor body and a rotor shaft, the rotor body is wholly or partly formed of ferromagnetic material and has a shape or a structure that can be attracted tangentially by the N pole or the S pole of the magnetized end. The input controller, an input circuit of which is closed or opened depending on an operation state of the rotor, is connected with an electromagnet coil that can be powered on to generate electromagnet to cancel the N pole or the S pole of the magnetized end and powered off to resume the N pole or the S pole of the magnetized end.

The permanent magnet disposed externally to one end of the electromagnet is a tent-shaped structure, composed of a plurality of permanent magnets, each of the permanent magnets has an N pole or an S pole facing one end of the electromagnet or inside the tent-shaped structure.

The rotor which has a shape or a structure that can be attracted tangentially by the N pole or the S pole of the magnetized end, has a star-shaped structure.

The star-shaped structure of the rotor is a bar-shaped structure, and is composed of at least two rotor bars.

The gap between the magnetized end of the electromagnet core and the rotor is less than 4 mm.

The controlled input controlled by the rotor is disposed at the base and connected with the electromagnetic coil.

The input controller, the electromagnet coil and an outreach electric appliance are connected in series.

The outreach electric appliance is an electric heating device or a ceramic heating element.

The input controller is a mechanical current switch.

The input controller is a brush-type current switch.

The input controller is an electronic current switch.

The input controller is a photoelectric current switch.

The permanent magnet is formed of NdFeB material or strong magnetic material.

The tent-shaped permanent magnet is formed of NdFeB or magnetic plastic material.

The tent-shaped permanent magnet is a single layer or a multilayer.

The rotor shaft is provided with a fan blade at one end thereof.

The outreach electric appliance is disposed in front of the fan blade.

The outreach electric appliance is disposed in front of the rotor bar.

The stator is divided into one or more groups.

The rotor is a “linear rotor”.

The device is started manually.

The device is started by a starter.

The electromagnet coil is a conventional coil.

The electromagnet coil is a high temperature resistant coil.

The electromagnetic coil is a superconducting coil.

The electromagnetic coil is a graphene coil.

The implementation process of the present invention (firstly started manually or by a starter):

After being powered off (within a certain time), the external permanent magnet magnetizes an N pole or an S pole at the magnetized end though the electromagnet core—attracting the rotor body tangentially. During this process, the rotor is rotated to do work and outputs a part of mechanical energy to the outside.

After being powered on (within a certain time), the electromagnet generates electromagnet to cancel the pole or the S pole magnetized at the magnetized end through the electromagnet core by the external permanent magnet—releasing the permanent magnetic force attracting the rotor body radially at the magnetized end of the core—producing a zero magnetic force at the magnetized end. Then the rotor body may keep rotating by the existing inertia formed in the above process and pass across the magnetized end of the core. During this process, since the environment where the rotor body passes across the magnetized end of the core is an environment with zero magnetic force, the input current will not be caused to change at all when the rotor is rotated or passes across the magnetized end of the core, so the input electrical energy is transformed into thermal energy completely—the coil generating heat. (If the zero magnetic force cannot be produced at the magnetized end, the rotor attracted tangentially by the magnetized end will be attracted radially and the device will be shut down. Obviously, the present invention only needs a tangential attraction, does not need a radial attraction.)

The process is cycled as such continuously (depending on the control of the input controller), and thus the electric heating device will continuously generate heat and continuously rotate, that is, continuously and alternatively output thermal energy and mechanical energy.

Since the input electrical energy may be transformed into thermal energy completely, on the basis of following the law of conservation of energy, an output greater than an input may be perfectly realized by outputting a sum of two forms of energy. Since the output may be greater than the input, the “output efficiency” may be greater than 100%.

There may be a situation that, the conservation process of electrical energy transformed into thermal energy exits no matter the rotor rotates or not; the conservation process of electrical energy transformed into thermal energy exits no matter the mechanical energy is output or not.

If the generating heat of the coil needs to be controlled and reduced while the device is desired to have a considerably effect of generating heat and blowing warm air, it is may be easily achieved by connecting an outreach heat-generated electric appliance such as a ceramic heating element or an electric heating pipe with the coil in series (thus, the coil may be wound with conventional enamelled wires. Of course, it is best if graphene enamelled wires are used).

When the coil is a superconducting coil, the device may “do work to the outside without consuming energy”.

The present invention may by permanent magnetically actuated by inputting electrical energy. The differences between the device and the others are: 1. firstly realizing outputting two forms of energy by inputting one form of energy; 2. generating heat by electrical energy and blowing warm air by actuation of permanent magnet; 3. having a significant energy saving effect.

The utility model not only may achieve an output greater than an input, but also may achieve a 100% “output efficiency”. If the device as an electric warm air unit is put into market, its unprecedented “output efficiency” and energy saving effect will cause great concern to the country and the world market of electric warm air units.

### BRIEF DESCRIPTION OF THE DRAWINGS

FIG. 1 is a structural view of a specific embodiment of the present invention.

FIG. 2 and FIG. 3 is a schematic diagram of the operation of the device in FIG. 1.

In the accompany drawings, 1 is a permanent magnet, 2 is an electromagnet, 3 is a coil, 4 is a rotor, 5 is a rotor shaft, 6 is a core, 7 is a magnetic end, 8 is a gap, 9 is an input controller, 10, 11, 12,13,14,15 are rotating bars, and 16 is a base.

### DETAILED DESCRIPTION OF THE EMBODIMENTS

Hereinafter, the present invention is further explained with reference to the accompanying drawings and embodiments.

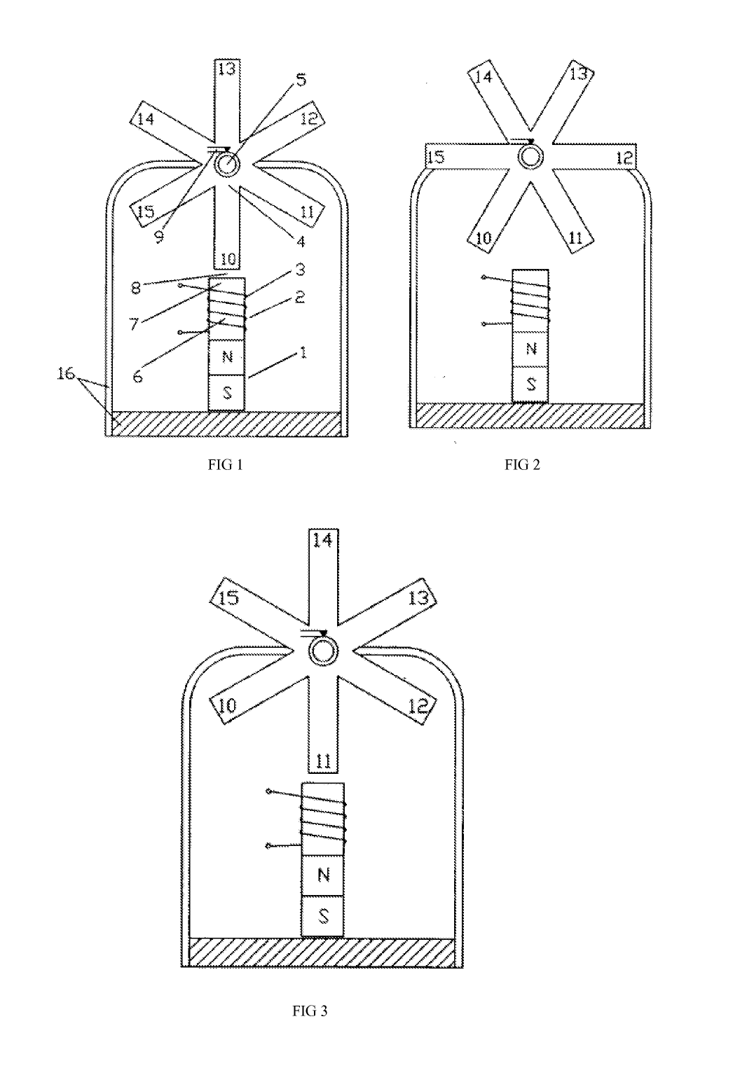

FIG. 1 is one embodiment of the present invention, comprising a stator, a rotor, an input controller and a base. The stator is composed of a permanent magnet 1 and an electromagnet 2. The NdFeB permanent magnet 1 is connected to one end (a lower end) of an electromagnet core 6. The rotor is composed of a rotor body 4 and a rotor shaft 5. The rotor body 4 is a star-shaped silicon steel structure. The star-shaped rotor body 4 has fan-shaped six rotor bars that respectively are 10, 11, 12, 13, 14 and 15 (function as a flywheel and have functions of dissipating heat by blowing air and directionally heating). A magnetized end 7 at the other end (an upper end) of the electromagnet core 6 faces the rotor body 4. A working gap 8 between the magnetized end 7 and each of the rotor bars 10, 11, 12, 13, 14 and 15 is 3 mm; a magnetic pole magnetized by the magnetized end 7 under an action of the external permanent magnet 1 is an N pole. The input controller 9 placed at the base is a brush-type current switch, connected in series with an electromagnet coil 3 that is high temperature resistant, and is controlled by the rotor shaft 5. The stator and the rotor are supported by the base 6.

The features of operation of this embodiment are as follows.

Before the device is started (before an external DC power supply is switched on), any one of the six rotor bars 10, 11, 12, 13, 14 and 15 of the rotor body 4 may be attracted randomly by a permanent magnetic force generated by the external permanent magnet 1 through the magnetized end 7 of the electromagnet core. As shown in FIG. 1, the rotor bar 10 is attracted randomly by the magnetized end 7.

After the external DC power supply is switched on, the electromagnet coil 3 is powered on to generate heat and electromagnet (a magnetic pole thereof is opposite to the pole of the permanent magnet) under an action of the closing of the input controller 9, so as to release the trap to the rotor bar 10 by the external permanent magnet 1 through the magnetized end 7 of the electromagnet core—the permanent magnetic force of the magnetized end 7 is cancelled to zero by the electromagnetic force (producing a zero magnetic force). After the trap is released, the rotor body 4 is still in a stationary state, and the rotor bar 10 still faces the magnetized end 7. Since the trap to the rotor bar 10 by the magnetized end 7 is released, the rotor 4 may be started clockwise by an external force (by manually started). After the rotor 4 is started, the rotor bars 10, 11, 12, 13, 14 and 15 functioning as a flywheel may rotate clockwise by inertia—the rotor 10 smoothly passing across the magnetized end 7. So far, the operation is started.

Experiments show, after the coil is powered on, the permanent magnetic force of the magnetized end 7 is cancelled to zero by the electromagnetic force, so an input current will not be caused to change at all at the moment the rotor bars 10, 11, 12, 13, 14 and 15 passes across the magnetized end 7 by inertia, and the input electrical energy is transformed into thermal energy completely (the coil generating heat), i.e. the consumed electrical energy is completely focused on the heating of the device. Since the input electrical energy is transformed into thermal energy completely, the rotor bars 10, 11, 12, 13, 14 and 15 do not consume electrical energy in a process of rotating to blow air for dissipating heat, i.e. do not compete for electrical energy with the process of generating heat. In other words, it remains intact that electricity generating heat follows the process of conservation of energy, only a possibility of actuation by permanent magnet is achieved through the transforming process of electricity generating heat or the consumption process of the input electrical energy, so as to offer “power” for the blowing air for dissipating heat without an external force. The difference lies in that: a conventional electric warm air unit is double powered, and the heating part and the blowing air part for dissipating heat are powered separately, while according to the present invention, only the heating part needs to be powered, and the blowing air part for dissipating heat needs not to be powered.

The operation of this embodiment (started manually) is as follows.

The external DC power supply is switched on, and the high temperature resistant coil 3 is powered on through the closed input controller 9. The coil 3 is powered on to generating heat, and to cause the electromagnet 2 to generate an opposite magnetic pole (an S pole) at the magnetized end 7 to release the trap to the rotor bar 10 by the external permanent magnet 1 through the magnetized end 7 of the electromagnet core—producing a zero magnetic force at an interface of the magnetized end 7. Then, by rotating the rotor body 4 clockwise manually, the rotor bar 10 passes across the magnetized end 7 smoothly by inertia formed when the rotor body 4 is rotated clockwise manually. After the rotor body 4 is rotated by a certain angle clockwise, the rotor bars 10, 11, 12, 13, 14 and 15 is rotated from positions shown in FIG. 1 to positions shown in FIG. 2 (rotated by 32 degree). During this process, since the environment where the rotor bar 10 passes across the magnetized end 7 is an environment with zero magnetic force, the input current will not be caused to change at all by the rotor bar 10 passing across the magnetized end 7, therefore, the input electrical energy is transformed into thermal energy completely—the coil 3 generating heat.

When the rotor bars 10, 11, 12, 13, 14 and 15 are rotated from the positions shown in FIG. 1 to the positions shown in FIG. 2, the contact points of the input controller 9 are opened and the coil 3 is powered off. At this time, the rotor bar 10 and the magnetized end 7 form an angle of 32 degree, and the rotor bar 11 and the magnetized end 7 form an angle of 28 degree. (The difference between the rotation angles of the two bars is 4 degree. The difference in the rotation angles may be properly increased if it is desirable, so as to further lengthen a distance between the rotor bar 10 and the magnetized end 7 and shorten a distance between the rotor bar 11 and the magnetized end 7.)

After the coil 3 is powered off, the external permanent magnet 1 provides permanent magnetic attraction force to the rotor body 4 through the magnetized end 7 of the electromagnet core. This magnetic force affects the rotor bars 10 and 11 shown in FIG. 2 meantime. However, since the distance between the rotor 11 and the magnetized end 7 is less than the distance between the rotor 10 and the magnetized end 7 and due to an action of the inertia formed after the rotor body 4 is started, the rotor bar 11 will be attracted by the magnetized end 7 eventually, the rotor body 4 does work and outputs (partly) it—blowing air for dissipating heat—keep rotating clockwise, and the rotor bars 10, 11, 12, 13, 14 and 15 are rotated from the positions shown in FIG. 2 to positions shown in FIG. 3 (rotated by 28 degree). During this process, a force attracting the rotor bar 11 tangentially by the magnetized end 7 becomes large from small.

When the rotor bars 10, 11, 12, 13, 14 and 15 are rotated from the positions shown in FIG. 2 to the positions shown in FIG. 3, under the action of the closing of the input controller 9, the coil 3 is powered on again. The coil 3 generates electromagnet immediately and rapidly releases the trap to the rotor bar 10 by the external permanent magnet 1 through the magnetized end 7 of the electromagnet core—producing a zero magnetic force at the interface of the magnetized end 7 again. Subsequently, the rotor body 4 brings the rotor bar 11 to pass across the magnetized end 7 smoothly by inertia (rotated further by 32 degree), and the electromagnet coil 3 generates heat again. So far, the rotor body 4 enters an automatic operation process.

The process is cycled as such continuously (depending on the control of the input controller 9), the coil 3 continuously generates heat, and the rotor bars 10, 11, 12, 13, 14 and 15 are continuously rotated clockwise—continuously blowing air for dissipating heat.

The process is cycled as such continuously (depending on the control of the input controller 9), and thus the electric heating device may generate heat and blow warm air continuously and alternatively.

It should be noted that producing a zero magnetic force at the interface of the magnetized end 7 is critical to the present invention. After the zero magnetic force is produced, in the case that the rotation speed is keep constant, even a cross sectional area of each of the rotor bars 10, 11, 12, 13, 14 and 15 is increased, the input current will not change when the rotor bars 10, 11, 12, 13, 14 and 15 pass across the magnetized end 7 by inertia (compared with the case before they are increased, including comparison at the moment of powering on and in a stable state), so the input power keeps constant. However, (after powering off), the ability of being attracted and doing work of the increased rotor bars 10, 11, 12, 13, 14 and 15 may be increased significantly then. Obviously, the ability of actuation by permanent magnet is independent of the input power.

The producing of the zero magnetic force not only depends on a size of the input current, but also depends on factors such as a size of an inductance of the coil 3 and a closing time of the input controller 9. Due to an inductive effect, different rotation speeds need to correspond to different input currents and different closing times. When the rotation speed of the rotor bars 10, 11, 12, 13, 14 and 15 is relatively fast, generally the input controller 9 needs to be closed earlier, so as to ensure one of the rotor bars 10, 11, 12, 13, 14 and 15 is exactly in a desirable environment with zero magnetic force when it is rotated to the magnetized end 7.

If the zero magnetic force cannot be produced at the interface of the magnetized end 7 accurately and timely, the input current will be caused to fluctuate when the rotor bars 10, 11, 12, 13, 14 and 15 passes across or reaches the magnetized end 7, and thus the work done by blowing air for dissipating heat by the rotor bars 10, 11, 12, 13, 14 and 15 will partly come from an external input and will not be actuated purely by the permanent magnet, however, the relationship that an output is greater than an input will not be destroyed.

If the zero magnetic force may be produced at the interface of the magnetized end 7 accurately and timely, then the fluctuation no longer exists. Due to the inductive effect, at the moment the coil 3 is powered on, the work done by the rotor bars 10, 11, 12, 13, 14 and 15 rapidly blowing air for dissipating heat may be mixed with some input component (relating to some mechanical energy generated from mechanical energy). When the “component” is small, it may be neglected (even if it is counted in, the establishment of “an output greater than an input” will not be affected). When the “component” is large, the establishment of “an output greater than an input” will not be affected either, but a situation of inputting one form of energy and outputting three forms of energy will occur: inputting—electrical energy, outputting—thermal energy generated from mechanical energy+mechanical energy generated from mechanical energy+mechanical energy generated from (permanent) magnetic energy. At this time, the input electrical energy is not transformed into thermal energy 100%, but the transform process of electrical energy following the law of conservation of energy will not be affected.

It should be particularly noted that, generating heat by electricity is not limit to generating heat by the coil. Heat generated by any part of the device all belong to the category of generating heat and thus may be utilized, whether large or small.

It should be mentioned that, if the generating heat of the coil needs to be controlled and minimized while the device is desired to have a considerably effect of actuation by permanent magnet, it is may be easily achieved by connecting an outreach electric appliance with the coil in series. The outreach electric appliance may be an electric appliance with a large power, such as an electric heating device, an air conditioner, an electric motor (even including an electricity generator). The work done by the actuation by permanent magnet achieved by this “derivative” way may be fed to the outreach electric appliance such as an outreach electric appliance, to further improve an output efficiency of the outreach electric appliance, which will realize a new technical breakthrough in saving energy and reducing emission. (Currently, it may be realized by using conventional enamelled wires. In the future, graphene coils or superconducting coils may be extensively used).

What is claimed is:

1. An electric heating device with an output greater than an input, comprising a stator, a rotor, an input controller and a base, characterized in that:
the stator is composed of a permanent magnet and an electromagnet, the permanent magnet is disposed externally around one end of the electromagnet or connected to one end of an electromagnet core, the permanent magnet disposed externally or connected to one end of the electromagnet can magnetize an N pole or an S pole at the other end of the electromagnet core, a magnetized end magnetized with the N pole or the S pole faces the rotor and maintains a gap with the rotor;
the rotor is composed of a rotor body and a rotor shaft, the rotor body is wholly or partly formed of ferromagnetic material and has a shape or a structure that can be attracted tangentially by the N pole or the S pole of the magnetized end;
the input controller, an input circuit of which is closed or opened depending on an operation state of the rotor, is connected with an electromagnet coil that can be powered on to generate electromagnet to cancel the N pole or the S pole of the magnetized end and powered off to resume the N pole or the S pole of the magnetized end.

2. The electric heating device with an output greater than an input according to claim 1, characterized in that: the permanent magnet disposed externally to one end of the electromagnet is a tent-shaped structure, composed of a plurality of permanent magnets, each of the permanent magnets has an N pole or an S pole facing one end of the electromagnet or inside the tent-shaped structure.

3. The electric heating device with an output greater than an input according to claim 1, characterized in that: the rotor which has a shape or a structure that can be attracted tangentially by the N pole or the S pole of the magnetized end, has a star-shaped structure, and the star-shaped rotor is composed of at least two rotor bars.

4. The electric heating device with an output greater than an input according to claim 1, characterized in that: the input controller, the electromagnet coil and an outreach electric appliance are connected in series.

5. The electric heating device with an output greater than an input according to claim 2, characterized in that: the input controller, the electromagnet coil and an outreach electric appliance are connected in series.

6. The electric heating device with an output greater than an input according to claim 3, characterized in that: the input controller, the electromagnet coil and an outreach electric appliance are connected in series.

7. The electric heating device with an output greater than an input according to claim 1, characterized in that: the electromagnet coil is a high temperature resistant coil.

8. The electric heating device with an output greater than an input according to claim 2, characterized in that: the electromagnet coil is a high temperature resistant coil.

9. The electric heating device with an output greater than an input according to claim 3, characterized in that: the electromagnet coil is a high temperature resistant coil.
